(19) United States
(12) Patent Application Publication
(10) Pub. No.: US 2025/0141497 A1
(43) Pub. Date: May 1, 2025

(54) PASSIVE SELF-ANNOUNCING RECONFIGURABLE INTELLIGENT SURFACE

(71) Applicant: NEC Laboratories Europe GmbH, Heidelberg (DE)

(72) Inventors: Francesco Devoti, Heidelberg (DE); Lanfranco Zanzi, Heidelberg (DE)

(21) Appl. No.: 18/434,866

(22) Filed: Feb. 7, 2024

Related U.S. Application Data
(60) Provisional application No. 63/545,559, filed on Oct. 25, 2023.

(51) Int. Cl. H04B 7/04; H04B 7/06; H04L 25/02

(52) U.S. Cl. CPC H04B 7/04013; H04B 7/0617; H04L 25/0202

(57) ABSTRACT

A passive self-announcing reconfigurable intelligent surface (RIS). The passive self-announcing RIS includes reconfigurable elements configured for controllable reflections, and self-conjugating elements disposed together with the reconfigurable elements on a single passive reflective surface. The present invention can be used in a variety of applications including, but not limited to, RIS presence detection, RIS communication systems, and RIS signal propagation.

### CROSS-REFERENCE TO PRIOR APPLICATION

Priority is claimed to U.S. Provisional Application Ser. No. 63/545,559 filed on Oct. 25, 2023, the entire contents of which is hereby incorporated by reference herein.

### FIELD

The present invention relates to a reconfigurable intelligent surface (RIS).

### BACKGROUND

Reconfigurable intelligent surfaces (RISs) are devices that can be deployed to control the propagation environment in a programmable manner. They are typically composed of uniform planar arrays of antennas that relate to low-cost passive components allowing to control the way each antenna element reflects the signal, typically by means of altering the phase of the signal being re-irradiated. Such ability can be used to control and enhance reflection properties of impeding signals, e.g., to steer the reflection paths in the desired direction by means of the so-called passive beamforming technique (see Albanese, A., Devoti, F., Sciancalepore, V., Di Renzo, M., and Costa-Pérez, X., “MARISA: A Self-configuring Metasurfaces Absorption and Reflection Solution Towards 6G,” IEEE INFOCOM (2022), which is hereby incorporated by reference herein).

The ability of changing the propagation channel conditions at will, and their very low cost compared to traditional (active) wireless devices, makes them particularly interesting for several applications ranging from communication enhancement to electromagnetic shielding. They also find uses in wireless sensing and localization applications, as well as joint communication and sensing applications, wherein they can enhance the coverage and range of action of deployed devices and enhance their sensing capabilities (see Liu, R., Li, M., Luo, H., Liu, Q., and Swindlehurst, A. L., “Integrated sensing and communication with reconfigurable intelligent surfaces: Opportunities, applications, and future directions,” IEEE Wireless Communications, 30 (1), 50-57 (2023), which is hereby incorporated by reference herein).

Depending on their hardware characteristics, RISs are featured with a bandwidth and an area of influence. The bandwidth of influence defines the range of frequencies that can be affected by an RIS, i.e., signals that are subject to anomalous reflections when the RIS is in their propagation path. The area of influence specifies the spatial area wherein such effects can be perceived by a receiver, i.e., the RIS presence and configuration translate in a non-negligible change of the received signal properties, e.g., measured signal quality, bit-error rate, localization accuracy, etc., which may in turn affect the communication/sensing performance (see Alexandropoulos, G. C., Phan-Huy, D. T., Katsanos, K. D., Crozzoli, M., Wymeersch, H., Popovski, P., Ratajczak, P., Bénédic, Y., Hamon, M. H., Gonzalez, S. H., Mursia, P., Rossanese, M., Sciancalepore, V., Gros, J. B., Terranova, S., Gradoni, G., Di Lorenzo, P., Rahal, M., Denis, B., D'Errico, R., Clemente, A., and Strinati, E. C., “RIS-enabled smart wireless environments: Deployment scenarios, network architecture, bandwidth and area of influence,” arXiv preprint arXiv: 2303.08505 (2023), which is hereby incorporated by reference herein).

### SUMMARY

In an embodiment, the present invention provides a passive self-announcing reconfigurable intelligent surface (RIS). The passive self-announcing RIS includes reconfigurable elements configured for controllable reflections, and self-conjugating elements disposed together with the reconfigurable elements on a single passive reflective surface. The present invention can be used in a variety of applications including, but not limited to, RIS presence detection, RIS communication systems, and RIS signal propagation.

### BRIEF DESCRIPTION OF THE DRAWINGS

Embodiments of the present invention will be described in even greater detail below based on the exemplary figures. The present invention is not limited to the exemplary embodiments. All features described and/or illustrated herein can be used alone or combined in different combinations in embodiments of the present invention. The features and advantages of various embodiments of the present invention will become apparent by reading the following detailed description with reference to the attached drawings which illustrate the following:

FIG. 1 schematically illustrates an example of an RIS used for communication enhancement;

FIG. 2 schematically illustrates an example of RIS used for a sensing application;

FIG. 3 schematically illustrates a self-conjugating reflective surface (SCRS);

FIG. 4 schematically illustrates a passive self-announcing RIS (P-SARIS) hardware architecture according to an embodiment of the present invention;

FIG. 5 illustrates an example of obtained beam patterns with a side-by-side elements displacement, surface with 32×2 elements, and elements inter-distance of 50% wavelength, where frequency is set to 5 GHz;

FIG. 6 illustrates an example of obtained beam patterns with a chessboard elements displacement, surface with 32×2 elements, and elements inter-distance of 50% wavelength, where frequency is set to 5 GHz;

FIG. 7 illustrates an example of obtained beam patterns with a chessboard elements displacement, surface with 32×2 elements, and elements inter-distance of 30% wavelength, where frequency is set to 5 GHz;

FIG. 8 illustrates an example of a frame structure once the retroreflected signal has been demodulated ø;

FIG. 9 illustrates a block diagram of P-SARIS detection according to an embodiment of the present invention; and

FIG. 10 is a block diagram of an exemplary processing system, which can be configured to perform any and all operations disclosed herein.

### DETAILED DESCRIPTION

Embodiments of the present invention provide a passive self-announcing RIS that automatically broadcasts its presence in the area and reveals information on itself such as configuration, ID, etc. This advantageously allows devices operating in the area to account for the RIS presence to avoid communication and/or sensing drawbacks due to the influence of the RIS to signal propagation on radio signals.

In a first aspect, the present invention provides a passive self-announcing reconfigurable intelligent surface (RIS) comprising reconfigurable elements configured for controllable reflections; and self-conjugating elements disposed together with the reconfigurable elements on a single passive reflective surface.

In a second aspect, the present invention provides the passive self-announcing RIS according to the first aspect, wherein the self-conjugating elements include a phase shifter configured to add an additional phase shift to a retroreflected signal.

In a third aspect, the present invention provides the passive self-announcing RIS according to the first aspect or the second aspect, wherein the retroreflected signal is not amplified prior to retransmission.

In a fourth aspect, the present invention provides the passive self-announcing RIS according to any of the first to third aspects, further comprising a modulator configured to encode a preamble and data into a retroreflected signal.

In a fifth aspect, the present invention provides the passive self-announcing RIS according to any of the first to fourth aspects, wherein the modulator is configured to use binary phase shift key (BPSK) modulation.

In a sixth aspect, the present invention provides the passive self-announcing RIS according to any of the first to fifth aspects, wherein parameters of a modulation scheme used by the modulator are based at least in part on a communication system associated with the passive self-announcing RIS.

In a seventh aspect, the present invention provides the passive self-announcing RIS according to any of the first to sixth aspects, wherein the preamble and the data are encoded in a modulation frame of the retroreflected signal.

In an eighth aspect, the present invention provides the passive self-announcing RIS according to any of the first to seventh aspects, wherein the preamble enables the RIS to announce presence, and the data includes information about the RIS.

In a ninth aspect, the present invention provides the passive self-announcing RIS according to any of the first to eighth aspects, wherein encoding the preamble and the data into the retroreflected signal is repeated continuously or iteratively for a predefined time period.

In a tenth aspect, the present invention provides the passive self-announcing RIS according to any of the first to ninth aspects, wherein encoding the preamble and the data into the retroreflected signal is repeated according to a frequency that corresponds to the passive self-announcing RIS changing a reflection configuration.

In an eleventh aspect, the present invention provides the passive self-announcing RIS according to any of the first to tenth aspects, wherein the reconfigurable elements and self-conjugating elements are configured in a layout that optimizes beam characteristics for retroreflected beams and reflected beams from the reconfigurable elements and the self-conjugating elements.

In a twelfth aspect, the present invention provides a computer-implemented method for detecting and adapting to a passive self-announcing reconfigurable intelligent surface (RIS). A presence of the RIS is detected based on a preamble encoded into a retroreflected signal from the RIS. Information embedded in data of the retroreflected signal following the preamble is decoded. The decoded information is processed to adapt communication/sensing operations with the RIS.

In a thirteenth aspect, the present invention provides the method according to the twelfth aspect, further comprising correlating the retroreflected signal to known preambles, wherein adapting the communication/sensing operations with the RIS includes adapting a current configuration to synchronize with the RIS.

In a fourteenth aspect, the present invention provides the method according to the twelfth or thirteenth aspect, wherein adapting the current configuration to synchronize with the RIS includes using a modulation and coding scheme adaptation or advanced channel estimation techniques.

In a fifteenth aspect, the present invention provides the method according to any of the twelfth to fourteenth aspects, wherein the preamble includes a predefined sequence of symbols that are encoded in the retroreflected signal.

In a sixteenth aspect, the present invention provides the method according to any of the twelfth to fifteenth aspects, wherein the data includes a surface identification for the RIS, a current configuration for the RIS, a reflection configuration for the RIS, surface gain for the RIS, operational bandwidth for the RIS, beam width for the RIS, timing of reflection configuration changes for the RIS, global positioning system (GPS) information for the RIS, and/or an orientation of a surface of the RIS, and wherein the adapting the communication/sensing operations include using modulation and coding scheme adaptation, advanced channel estimation techniques, machine learning, or artificial intelligence.

In a seventeenth aspect, the present invention provides the method according to any of the twelfth to sixteenth aspects, wherein the RIS includes reconfigurable elements configured for controllable reflections and self-conjugating elements on a single passive reflective surface, wherein a phase shift is added to the self-conjugating elements, and wherein the retroreflected signal is modulated to encode the information in the retroreflected signal using phase modulation techniques by altering a phase of the retroreflected signal without altering reflection properties of the self-conjugating elements.

In an eighteenth aspect, the present invention provides the method according to any of the twelfth to seventeenth aspects, wherein the preamble is a pseudo-random noise sequence.

In a nineteenth aspect, the present invention provides a computer system for detecting and adapting to a passive self-announcing reconfigurable intelligent surface (RIS) comprising one or more processors, which, alone or in combination, are configured to perform a method for detecting and adapting to a passive self-announcing (RIS) according to any of the twelfth to eighteenth aspects.

In a twentieth aspect, the present invention provides a tangible, non-transitory computer-readable medium for detecting and adapting to a passive self-announcing reconfigurable intelligent surface (RIS) which, upon being executed by one or more hardware processors, provide for execution of a method according to any of the twelfth to eighteenth aspects.

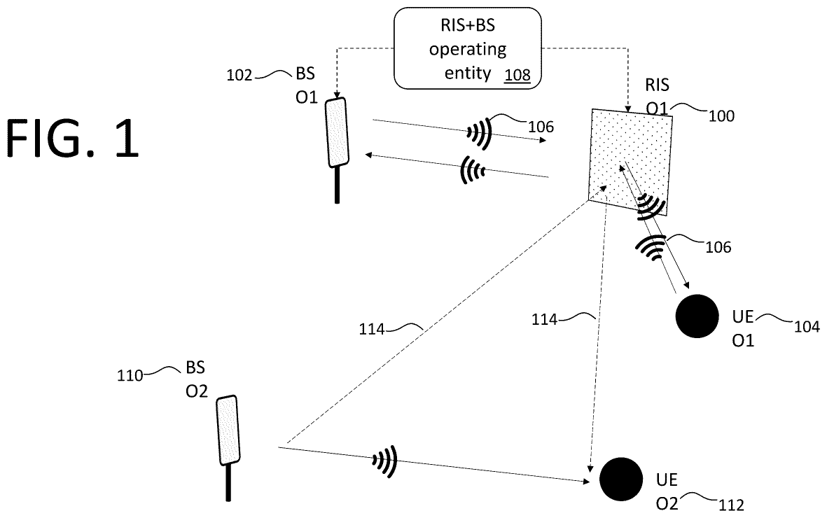

In the example depicted in FIG. 1, an RIS 100 owned by the operator O1 is present and used for communication enhancement, in particular, it is configured to steer the signal 106 of the base station (BS 102) of the operator O1 towards the user equipment (UE 104) O1 to optimize the channel conditions between the BS 102 and the user 104. In FIG. 1, the BS 102 and RIS 100 may include a RIS+BS operating entity 108. In this example, a BS 110 and a UE 112 belonging to another mobile operator O2 is also present. By considering overlapping bandwidth of influence of the RIS 100 with both the operating bandwidth of operators O1 and O2, the channel between the BS 110 of operator O2 and the UE 112 of operator O2 might be affected by the RIS 100 and cause changes in the channel conditions which might lead to an unwanted worsening of the communication performances for the operator O2—represented in FIG. 1 by 114.

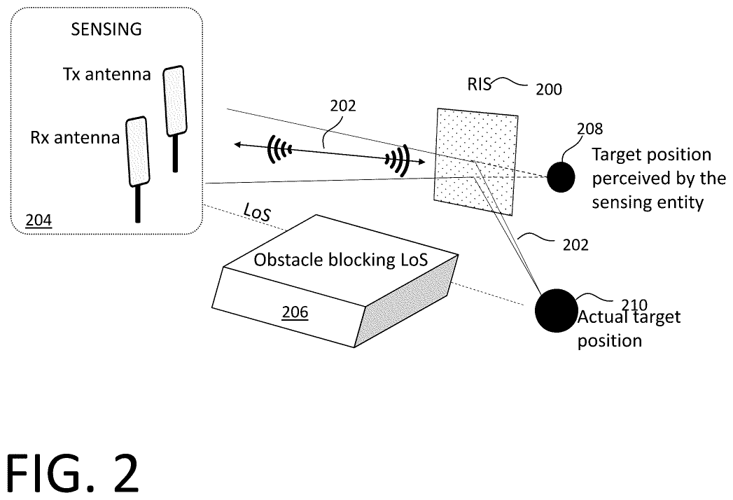

FIG. 2 illustrates an exemplary sensing application. Within these settings, the RIS 200 is used to reflect the signal 202 from a sensing entity 204 and reach areas that are not directly reachable from the source (204) due to an obstacle blocking the line-of-sight 206 (LoS). In this case, the RIS 200 behaves as a controllable (reconfigurable) mirror that allows to overcome obstacles, e.g., 206, and enlarge the sensing area.

Common detection algorithms are based on measuring signal reflection power and/or signal time of transmission/arrival. It should be noted that in the presence of such detection schemes, if the sensing entity, such as 204, operated without knowing about the RIS 200 location and configuration, the RIS 200 may lead to erroneous target location estimation, as the target position perceived by the sensing entity 208 would not correspond to the actual target position 210 due to the reflection introduced by the RIS 200.

Therefore, there exists the technical problem of how to be aware of and eventually compensate for the effects of the RIS, which need to be accounted in the target position estimation to avoid bias. This can be done only if the position and configuration of the RIS is known at the sensing entity. Embodiments of the present invention provide solutions to overcome this technical problem by providing context awareness in systems or applications involving the presence of RIS devices, allowing unaware sensing devices to gather and utilize information about its RIS configuration and presence in the deployment environment to improve performances or adapt their behavior. Although communication/sensing applications are used herein as example applications, other kinds of applications involving radio communication could benefit the additional context awareness on RIS deployment and therefore fall within the scope of embodiments of the present invention. For example, other technical applications such as robotics, autonomous driving, RADAR, etc. could be improved with the enhanced computer functionality of being able to add this additional context if operating in areas where RIS are deployed.

Thus, a technical problem overcome by embodiments of the present invention is that awareness about the presence of an RIS is not granted, and entities running communication/sensing services in the service area might be unwillingly affected by the presence of RIS. To avoid overcome this technical problem, embodiments of the present invention enable devices involved in communication and/or sensing tasks to be aware of the RIS presence and its configuration, and to be informed when it changes, which advantageously enables to avoid communication disruption or estimation bias.

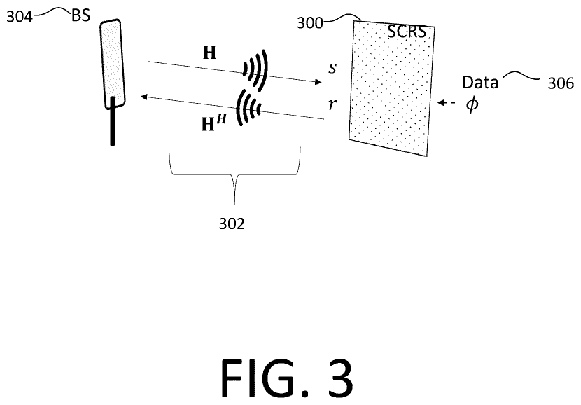

Self-conjugating reflective surfaces (SCRSs) 300 are man-made uniform planar arrays of antennas whose elements are designed in such a way that the reflected signal 302 is always the complex conjugate of the impinging one. In practice, such devices are similar to RISs, with the peculiarity of behaving as a static retroreflector, i.e., their reflection properties are fixed. In particular, the complex conjugate operation at each element of the SCRS 300 is equivalent to imposing a beam steering configuration on the reflected signal 302 that is always pointing toward the direction of arrival of the impinging one. In other words, the signal hitting an SCRS 300 is always retroreflected to the transmitter (e.g., BS 304). Interestingly, as illustrated in FIG. 3, this property can be combined with phase modulation schemes to embed information in the reflected signal—represented as data ¢ 306 (see Dardari, D., Lotti, M., Decarli, N., and Pasolini, G., “Grant-free Random Access with Self-conjugating Metasurfaces,” arXiv preprint arXiv: 2212.12453 (2022), which is hereby incorporated by reference herein).

Embodiments of the present invention introduce a new hardware architecture referred to herein as a passive self-announcing RIS (P-SARIS) that merges properties of RISs and SCRSs. Embodiments of the present invention allow to construct surfaces that are both capable of modifying the propagation properties of the signal, and back-propagate information towards the transmitting devices. While the former property enables the programmability of the radio channel, the latter property enables the surface to back-propagate information and reveal its presence to all the sensing/communicating devices that are operating in the area of influence of the surface. This allows to compensate and/or take into account the presence of the surface both in sensing and communication applications, hence avoiding performance degradation in devices that otherwise would be operating unbeknownst under the influence of surfaces deployed by third parties.

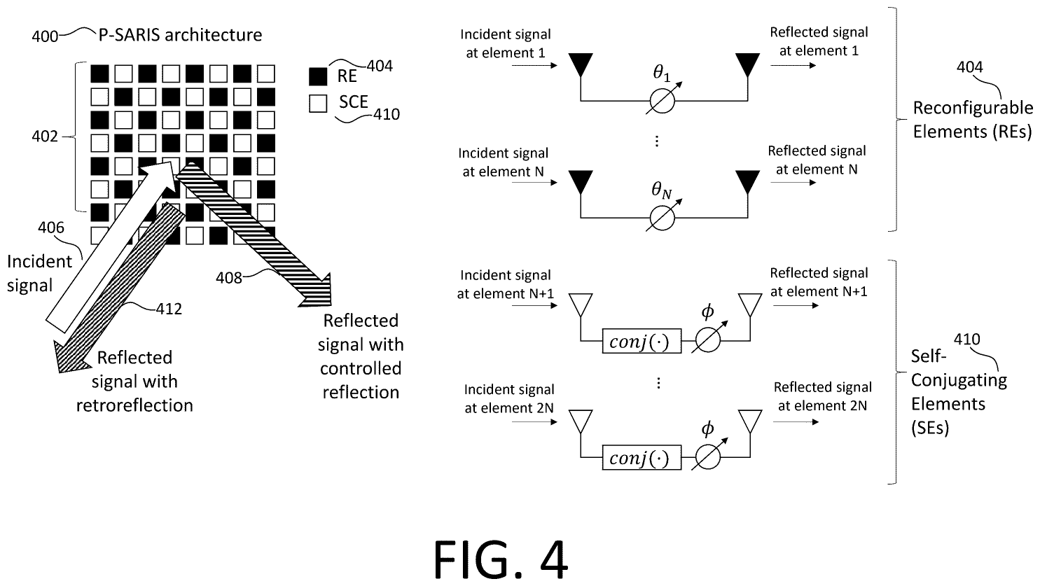

FIG. 4 depicts a P-SARIS architecture 400 according to an embodiment of the present invention. As an example, a surface 402 is shown comprising two times N reflective antenna elements, the first 1 . . . . N, denoted as reconfigurable elements (REs 404—represented as black squares) that are constructed in such a way that their reflection properties can be controlled independently by means of configuring the parameters θᵢ and αᵢ, which are denoting the phase shift and the gain imposed to the reflected signal at the i-th element, with i=1 . . . . N. Such elements can be controlled programmatically as in the standard RIS hardware to obtain the desired reflection properties via passive beamforming—represented in FIG. 4 as incident signal 406 and reflected signal with controlled reflection 408. The other N+1 . . . 2N elements, denoted as self conjugating elements (SCEs 410—represented as white squares), comprise passive radio-frequency (RF) hardware components that perform the conj (·) operation, i.e., the complex conjugate of the received signal. This operation is done in the same way for all SCEs and inherently constructs a reflection beam pattern that is pointing directly in the direction of the transmitter, i.e., retroreflecting the signal 412 as in the standard SCRS hardware, independently of the angle of arrival. These elements also include a phase shifter that imposes an additional phase shift ø to all the SCEs 410. More in general, this property can be exploited to encode information in the reflected signal by means of phase modulation techniques by altering the phase of the reflected signal, without altering the reflection properties of SCEs 410. Note that the retroreflected signal 412 is not amplified before retransmission, hence this operation is fully passive from the communication point of view. Notably, the subdivision and displacement of REs 404 and SCEs 410 forming the P-SARIS surface 402 could follow different ratio and element distribution patterns than the one depicted in the example.

The displacement and distribution patterns of the elements forming the P-SARIS can change its reflection properties in terms of obtained reflected and retroreflected beam patterns.

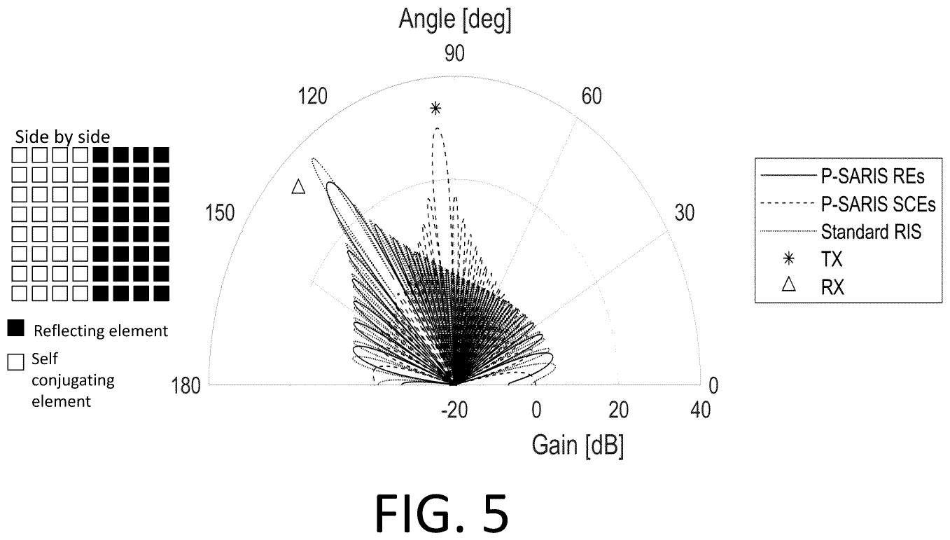

FIG. 5 illustrates the beam patterns obtained with a side-by-side configuration in comparison with a standard RIS with all reconfigurable elements. The P-SARIS (RE part) can reflect the signal in the same direction as the standard RIS, with a slightly lower gain due to the reduced number of elements available for configurable reflection and a slightly increased beamwidth. SCEs are effectively retroreflecting towards the transmitter.

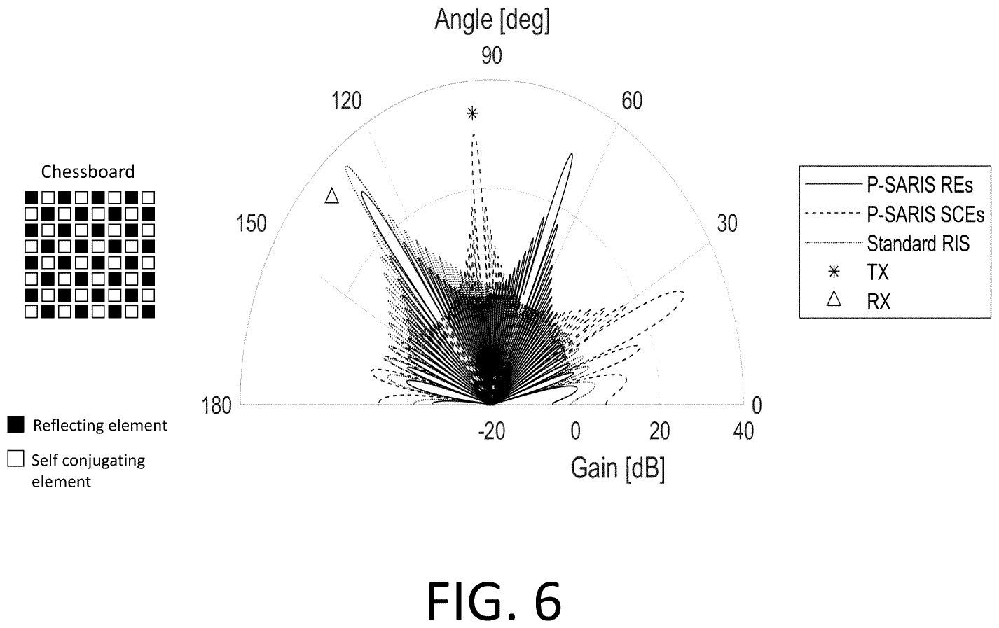

FIG. 6 illustrates a chessboard like elements displacement. Also in this case, the REs and SCEs parts have a slightly reduced gain with respect to the standard RIS. However, the resulting beamwidth is kept the same resulting in emerging sidelobes due to a higher spacing between elements belonging to the REs and the SCEs sets. Although FIGS. 5 and 6 depict two example configurations the current disclosure includes any other suitable configurations or layout of elements. For example, the REs and SCEs may be configured in a layout that optimizes desired beam characteristics of the retroreflected and reflected beams.

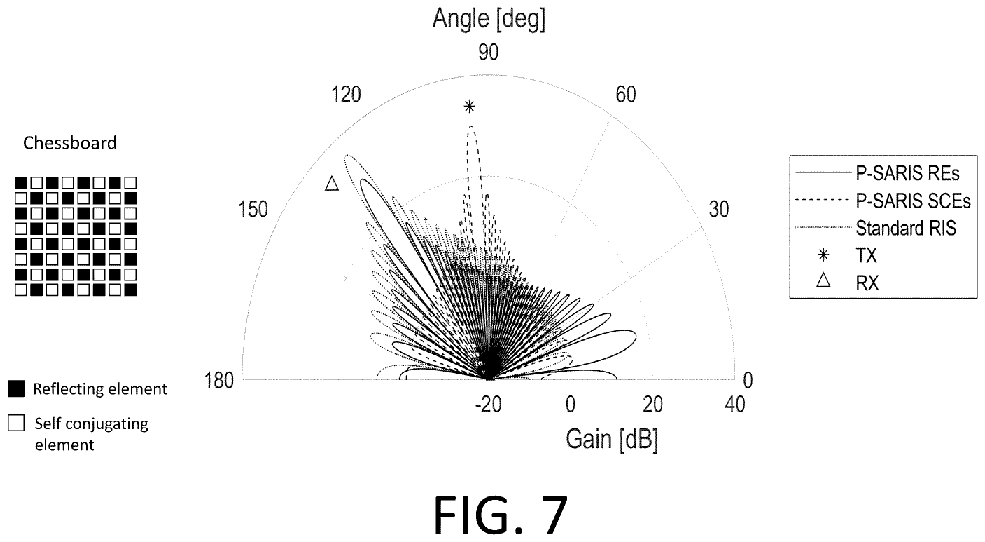

While keeping the chessboard setup, the sidelobes amplitude can be mitigated by reducing the elements inter distance, as shown in FIG. 7. In this case, however, mutual coupling effect may arise. This aspect can be considered and eventually compensated during the configuration optimization phase (see Mursia, P., Phang, S., Sciancalepore, V., Gradoni, G., and Di Renzo, M., “SARIS: Scattering aware reconfigurable intelligent surface model and optimization for complex propagation channels,” IEEE Wireless Communications Letters (2023), which is hereby incorporated by reference herein).

The data embedded in the P-SARIS retroreflected signal can be used to perform surface detection and broadcast useful information on the deployed surface. It can also be used to receive useful information from it and allow sensing/communicating devices to adapt their operations to account for the presence of the RIS.

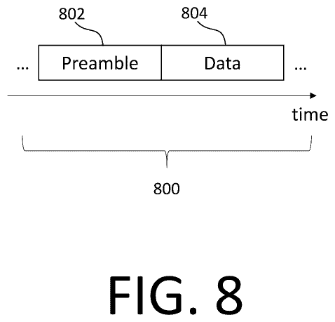

In an embodiment, the present invention considers a cyclical embedding of a preamble and data at the retroreflected signal ø. One possibility for it could be modulating the retroreflected signal ø according to a predefined frame structure 800 as depicted in FIG. 8. The current disclosure also includes frame structures which could be extended to accommodate additional parameters. In FIG. 8 the time attribute represents a time axis. The preamble 802 and data 804 transmissions are continuously repeated in time while the P-SARIS operates. The preamble 802 allows at the receiver side of the communication/sensing application to not only detect the presence of the RIS in the area, but also to acquire auxiliary information that may be used to, e.g., compensate for its presence. Such information is preferably encoded in a retroreflected frame composed of two main sections, a preamble 802 to acquire synchronization, and a payload (e.g., data 804) containing a set of useful information about the surface.

In an embodiment, the preamble 802 comprises a predefined sequence of symbols to be encoded in the retroreflected signal ø, and might be designed in such a way that it forms a sequence with strong autocorrelation. This would help the detection and frame synchronization task. For example, a pseudo-random noise (PN) sequence could be used as the preamble 802. However, different sequences can also be used in scenarios where multiple RISs are deployed. In embodiments the different sequences could be stored by the sensing/communicating device (within the sensing/transmission module or other protocol layers) to gain a better understanding of the deployment scenario and implement ad-hoc and informed corrections keeping track of the specific RIS/P-SARIS configurations which may even evolve over time.

Alternatively, it could also be that different surface manufacturers adopt different sequences. To detect the surface, the selected preamble(s) must be known at the receiver communication/sensing device. Hence, it must be publicly known and standardized to enable the detection of surfaces deployed by third parties.

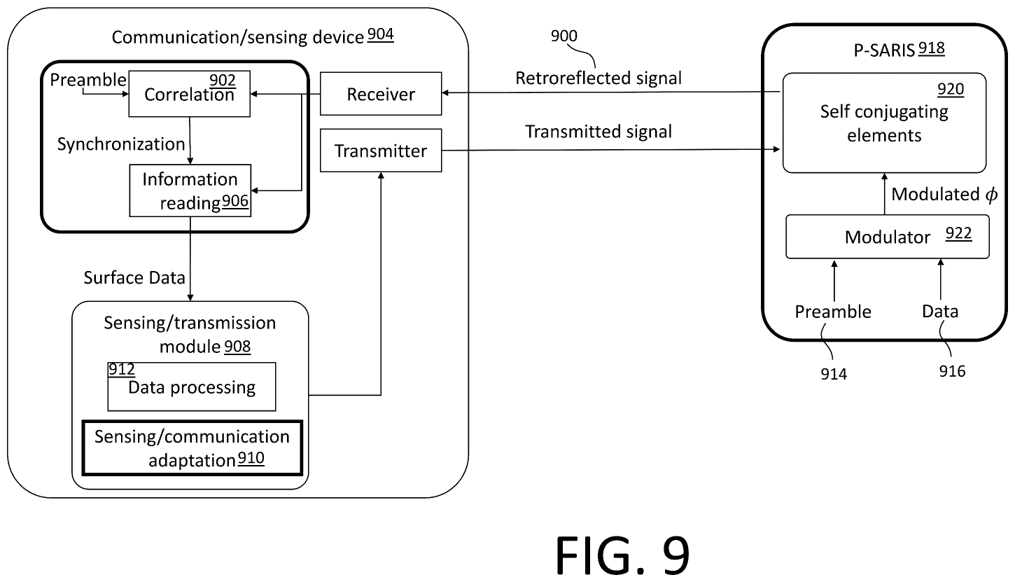

As depicted in FIG. 9, surface detection can be done by correlating the received signal coming from retroreflection 900 with one or more known preamble sequences. In embodiments, the received signal coming from retroreflection 900 includes preamble 914 and data 916. The correlation operation 902 provides both detection and synchronization information with the P-SARIS. The synchronization information is provided in the preamble: the use of sequences with high autocorrelation enables both detection and synchronization. In embodiments a correlation operation 902 between a known pseudo-random sequence S at the communication/sensing device 904 with a received signal R includes measuring the similarity between S and R. If the received signal R does not contain the same pseudo random sequence as S the correlation 902 between R and S will be very low. If the received signal R contains the same pseudo-random sequence as S, then correlation 902 will be high and exhibit a peak. The presence of the peak in the output of the correlation 902 enables the detection of the P-SARIS 918. The position of the peak in the output instead provides the time offset of S which in turn enables synchronization. The use of different pseudo random sequences enables the discrimination between different P-SARIS devices. For example, given a scenario where M RISs are deployed, the system would have S1, S2, . . . . SM sequences, and by considering the output of the correlation operation between R and each of them, it is possible to understand which RIS is transmitting by looking at the sequence that gives the higher correlation.

If a preamble is detected, the communication/sensing device 904 is synched with the P-SARIS 918 and processes the data 916 embedded in the signal following the preamble 914 through the information reading module 906. Such symbols might encode the following, non-exhaustive, set of information:
surface ID, current configuration (reflection configuration),
HW capabilities such as surface gain, operational bandwidth, beam width, timing of reflection configuration changes, etc., and
Information on the deployment of the surface, e.g., GPS coordinates and orientation of the surface could be embedded in the transmitted data.

Once the data 916 of the surface is available, it can be forwarded to the sensing/transmission module 908 of the communication/sensing device 904 where it can be processed 912 and used to adapt sensing/communication operation 910 to the presence of the RIS (P-SARIS 918). Processing 912 the data 916 may include an initial demodulation of the collected sensed/received data 916 so as to retrieve the predefined frame structure and related fields information, as well as an application specific processing to adapt the operations to the presence of the RIS/P-SARIS device 918. Adapting sensing/communication operation 910 include adjusting parameters based on a particular detected RIS and the particular information in the retroreflected signal 900. The information contained in the retroreflected signal 900 will depend on the specific RIS configuration. Several methods can be employed to perform sensing/communication adaptation, e.g., modulation and coding scheme adaptation, advanced channel estimation techniques, machine learning or artificial intelligence, etc. The P-SARIS 918 may include SCE(s) 920, and a modulator 922 for modulating the retroreflected signal ø. As an illustrative example, with reference to FIG. 2, a sensing device 204 deployed in the area (unaware of the presence of a RIS device (200)) would erroneously detect an object 208 due to the spontaneous reflection of the emitted electromagnetic signal 202 and the corresponding increase of measured KPIs like signal time of flight. Conversely, by knowing the RIS 200 location and its current configuration (e.g., location, azimuth and elevation angles of the reflection signal, operation frequency, etc.) the sensing device 204 would be able to compensate for the presence of the RIS 200 and detect the presence of an obstacle 206 (even in non-line-of-sight) by implementing geometrical corrections. Simple geometrical corrections are feasible approaches in this example, while larger deployments involving multiple RIS reflectors may require more advanced solutions. It becomes evident from the above example that it is hard to define a unique compensation strategy valid in all the use-cases, as the compensation actions would depend on the specific sensing algorithm implemented by the sensing device 204 and related measurement KPIs (e.g., time of flight, propagation delay, Doppler, etc.).

In an embodiment, the present invention provides a method comprising the steps of:
1) Designing a passive reflective surface comprising two sets of elements: one capable of controllable reflections and one capable of self-conjugation.
2) Adding to the self-conjugating elements an additional phase shift to enable modulation of the retroreflected signal with phase shift modulation schemes. In an example phase shift modulation may include binary phase shift key (BPSK) modulation where the value 0 in the data corresponds to a phase shift of 0 degrees and the value 1 in the data corresponds to a phase shift of 180 degrees. Given a sequence D of bits to be transmitted, which corresponds to the preamble and the data in the current disclosure, for each bit b in D: 1) the corresponding phase shift is selected (i.e., 0 degrees if b=0 or 180 degrees if b=1); 2) the phase shift is kept for the duration of a symbol, i.e., a duration of the transmission of a modulation symbol; and 3) select next bit b and return to 1). Parameters such as the duration of the symbol in time are set according to the specific requirements of a selected modulation scheme and the communication system. In the case of BPSK the duration of the symbol is the duration of the transmission of a single bit of information in the data stream as in the use case above, two symbols are used (0 and 180 degrees of phase shift) and they represent a single bit. In scenarios where a higher order PSK modulation is used the transmission of a single symbol encodes more than one bit of information in the data stream. For example, with a 4-PSK modulation the following symbol to bit mapping may apply:

| Symbol | Bits |
|---|---|
| 45 degrees | 00 |
| 135 degrees | 01 |
| −45 degrees | 10 |
| −135 degrees | 11. |

In this case the symbol duration corresponds to the transmission of two bits of information.
3) Modulating the retroreflected signal with a known preamble that enables communication/sensing devices to detect the presence of the surface and to encode a set of information on the surface status. This step is repeated in a predefined and known time frame. In embodiments the time frame structure and duration might be standardized, as well as the frame repetition schema. In principle, preamble and data transmissions could be continuously repeated over time. However different repetition strategies could be selected based on the specific scenario, for example depending on the frequency the RIS is changing reflection configuration.

At the communication/sensing device, the following steps are performed:
1) Leveraging the preamble to detect the surface presence.
2) Decoding information embedded in the data following the preamble.
3) Processing the decoded information and adapting communication/sensing operation to the surface presence and its current configuration.

Embodiments of the present invention provide for the following improvements and technical advantages over existing technology:
1. Introducing a new device design that blends together controllable reflective elements and self-conjugating elements to obtain a single passive reflective surface capable of both controllable reflections and retroreflections.
2. Providing a method that, through modulation of the retroreflected signal, enables the passive reflective surface to announce its presence (preamble) and any necessary or relevant information (data).
3. Providing a module at the receiver side that is able to detect the passive surface device by processing the information embedded in the retroreflected signal and adapting its communication/sensing operations.
4. Providing improved communication and sensing through RIS awareness.

In contrast to the device according to embodiments of the present invention, active RIS devices that may be used to directly transmit data and reveal their presence require more expensive hardware to behave as antennas and also lead to increased operational costs.

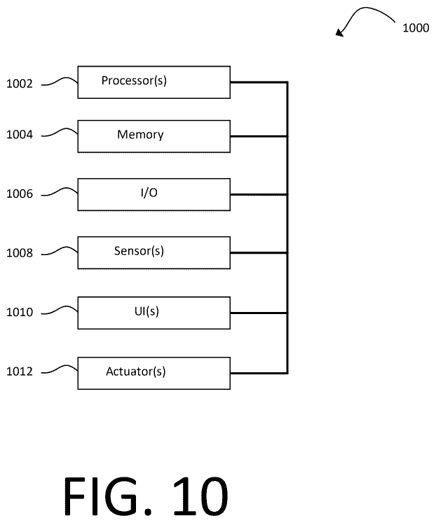

Referring to FIG. 10, a processing system 1000 can include one or more processors 1002, memory 1004, one or more input/output devices 1006, one or more sensors 1008, one or more user interfaces 1010, and one or more actuators 1012. Processing system 1000 can be representative of each computing system disclosed herein.

Processors 1002 can include one or more distinct processors, each having one or more cores. Each of the distinct processors can have the same or different structure. Processors 1002 can include one or more central processing units (CPUs), one or more graphics processing units (GPUs), circuitry (e.g., application specific integrated circuits (ASICs)), digital signal processors (DSPs), and the like. Processors 1002 can be mounted to a common substrate or to multiple different substrates.

Processors 1002 are configured to perform a certain function, method, or operation (e.g., are configured to provide for performance of a function, method, or operation) at least when one of the one or more of the distinct processors is capable of performing operations embodying the function, method, or operation. Processors 1002 can perform operations embodying the function, method, or operation by, for example, executing code (e.g., interpreting scripts) stored on memory 1004 and/or trafficking data through one or more ASICs. Processors 1002, and thus processing system 1000, can be configured to perform, automatically, any and all functions, methods, and operations disclosed herein. Therefore, processing system 1000 can be configured to implement any of (e.g., all of) the protocols, devices, mechanisms, systems, and methods described herein.

For example, when the present disclosure states that a method or device performs task “X” (or that task “X” is performed), such a statement should be understood to disclose that processing system 1000 can be configured to perform task “X”. Processing system 1000 is configured to perform a function, method, or operation at least when processors 1002 are configured to do the same.

Memory 1004 can include volatile memory, non-volatile memory, and any other medium capable of storing data. Each of the volatile memory, non-volatile memory, and any other type of memory can include multiple different memory devices, located at multiple distinct locations and each having a different structure. Memory 1004 can include remotely hosted (e.g., cloud) storage.

Examples of memory 1004 include a non-transitory computer-readable media such as RAM, ROM, flash memory, EEPROM, any kind of optical storage disk such as a DVD, a Blu-Ray® disc, magnetic storage, holographic storage, a HDD, a SSD, any medium that can be used to store program code in the form of instructions or data structures, and the like. Any and all of the methods, functions, and operations described herein can be fully embodied in the form of tangible and/or non-transitory machine-readable code (e.g., interpretable scripts) saved in memory 1004.

Input-output devices 1006 can include any component for trafficking data such as ports, antennas (i.e., transceivers), printed conductive paths, and the like. Input-output devices 1006 can enable wired communication via USB®, DisplayPort®, HDMI®, Ethernet, and the like. Input-output devices 1006 can enable electronic, optical, magnetic, and holographic, communication with suitable memory 1006. Input-output devices 1006 can enable wireless communication via WiFi®, Bluetooth®, cellular (e.g., LTE®, CDMA®, GSM®, WiMax®, NFC®), GPS, and the like. Input-output devices 1006 can include wired and/or wireless communication pathways.

Sensors 1008 can capture physical measurements of environment and report the same to processors 1002. User interface 1010 can include displays, physical buttons, speakers, microphones, keyboards, and the like. Actuators 1012 can enable processors 1002 to control mechanical forces.

Processing system 1000 can be distributed. For example, some components of processing system 1000 can reside in a remote hosted network service (e.g., a cloud computing environment) while other components of processing system 1000 can reside in a local computing system. Processing system 1000 can have a modular design where certain modules include a plurality of the features/functions shown in FIG. 10. For example, I/O modules can include volatile memory and one or more processors. As another example, individual processor modules can include read-only-memory and/or local caches.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A passive self-announcing reconfigurable intelligent surface (RIS), comprising:
reconfigurable elements configured for controllable reflections; and
self-conjugating elements disposed together with the reconfigurable elements on a single passive reflective surface.

2. The passive self-announcing RIS according to claim 1, wherein the self-conjugating elements include a phase shifter configured to add an additional phase shift to a retroreflected signal.

3. The passive self-announcing RIS according to claim 2, wherein the retroreflected signal is not amplified prior to retransmission.

4. The passive self-announcing RIS according to claim 1, further comprising a modulator configured to encode a preamble and data into a retroreflected signal.

5. The passive self-announcing RIS according to claim 4, wherein the modulator is configured to use binary phase shift key (BPSK) modulation.

6. The passive self-announcing RIS according to claim 4, wherein parameters of a modulation scheme used by the modulator are based at least in part on a communication system associated with the passive self-announcing RIS.

7. The passive self-announcing RIS according to claim 4, wherein the preamble and the data are encoded in a modulation frame of the retroreflected signal.

8. The passive self-announcing RIS according to claim 4, wherein the preamble enables the RIS to announce presence, and the data includes information about the RIS.

9. The passive self-announcing RIS according to claim 4, wherein encoding the preamble and the data into the retroreflected signal is repeated continuously or iteratively for a predefined time period.

10. The passive self-announcing RIS according to claim 9, wherein encoding the preamble and the data into the retroreflected signal is repeated according to a frequency that corresponds to the passive self-announcing RIS changing a reflection configuration.

11. The passive self-announcing RIS according to claim 1, wherein the reconfigurable elements and self-conjugating elements are configured in a layout that optimizes beam characteristics for retroreflected beams and reflected beams from the reconfigurable elements and the self-conjugating elements.

12. A computer-implemented method for detecting and adapting to a passive self-announcing reconfigurable intelligent surface (RIS), the computer-implemented method comprising:
detecting a presence of the RIS based on a preamble encoded into a retroreflected signal from the RIS;
decoding information embedded in data of the retroreflected signal following the preamble; and
processing the decoded information to adapt communication/sensing operations with the RIS.

13. The computer-implemented method according to claim 12, further comprising correlating the retroreflected signal to known preambles, wherein adapting the communication/sensing operations with the RIS includes adapting a current configuration to synchronize with the RIS.

14. The computer-implemented method according to claim 13, wherein adapting the current configuration to synchronize with the RIS includes using a modulation and coding scheme adaptation or advanced channel estimation techniques.

15. The computer-implemented method according to claim 12, wherein the preamble includes a predefined sequence of symbols that are encoded in the retroreflected signal.

16. The computer-implemented method according to claim 12, wherein the data includes a surface identification for the RIS, a current configuration for the RIS, a reflection configuration for the RIS, surface gain for the RIS, operational bandwidth for the RIS, beam width for the RIS, timing of reflection configuration changes for the RIS, global positioning system (GPS) information for the RIS, and/or an orientation of a surface of the RIS, and wherein the adapting the communication/sensing operations include using modulation and coding scheme adaptation, advanced channel estimation techniques, machine learning, or artificial intelligence.

17. The computer-implemented method according to claim 12, wherein the RIS includes reconfigurable elements configured for controllable reflections and self-conjugating elements on a single passive reflective surface, wherein a phase shift is added to the self-conjugating elements, and wherein the retroreflected signal is modulated to encode the information in the retroreflected signal using phase modulation techniques by altering a phase of the retroreflected signal without altering reflection properties of the self-conjugating elements.

18. The computer-implemented method according to claim 12, wherein the preamble is a pseudo-random noise sequence.

19. A computer system for detecting and adapting to a passive self-announcing reconfigurable intelligent surface (RIS), the computer system comprising one or more hardware processors which, alone or in combination, are configured to provide for execution of the following steps:
detecting a presence of the RIS based on a preamble encoded into a retroreflected signal from the RIS;
decoding information embedded in data of the retroreflected signal following the preamble; and
processing the decoded information to adapt communication/sensing operations with the RIS.

20. A tangible, non-transitory computer-readable medium having instructions thereon which, upon being executed by one or more processors, provide for detecting and adapting to a passive self-announcing reconfigurable intelligent surface (RIS) by providing for execution of the method according to claim 1.
